(19) United States
(12) Patent Application Publication
(10) Pub. No.: US 2008/0077691 A1
(43) Pub. Date: Mar. 27, 2008

(54) METHOD AND APPARATUS FOR SELECTING TELECOMMUNICATION SERVICE MODE

(75) Inventors: Mi Ryong PARK, Daejeon (KR); Man Seok Yang, Daejeon (KR); Tae Man Han, Daejeon (KR); Dong Sun Lim, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 11/939,998

(22) Filed: Nov. 14, 2007

(30) Foreign Application Priority Data
Apr. 12, 2006 (KR) 10-2006-0121378

(51) Int. Cl. G06F 15/173

(52) U.S. Cl. 709/226

(57) ABSTRACT

Provided is a method of determining a mode in a multi-mode terminal. The method includes the steps of: receiving key input of a telephone number; displaying a connectable service mode corresponding to the key input of the telephone number; receiving key input corresponding to the service mode; determining a prefix corresponding to the key input of the service mode; and adding the determined prefix in front of the telephone number to be transmitted, wherein the connectable service mode is automatically renewed in the region where the service is provided. Also, a multi-mode terminal is provided.

### CROSS-REFERENCE TO RELATED APPLICATION

This application claims priority to and the benefit of Korean Patent Application No. 2006-0121378, filed Dec. 4, 2006, the disclosure of which is incorporated herein by reference in its entirety.

### BACKGROUND

1. Field of the Invention

The present invention relates to a method and apparatus for selecting a telecommunication service mode.

2. Discussion of Related Art

Developments in telecommunications and wireless data communications have led communication service providers to provide services using wired, wireless or combined networks. Also, a user may desire to access various mobile communication services using one terminal, depending on circumstances.

Meanwhile, a user generally chooses a desired service mode due to call charges, service quality, etc. Thus, to meet demand for the desired connection, a certain prefix defined by a communication service provider is given to a base station or a repeater. When a user attempts to make a call to a phone number associated with a prefix, the call is coupled to a desired network by a transit exchange.

However, conventionally, a desired prefix is previously assigned to a telephone number on a per user basis, and thus one telephone number is managed several times according to service modes. As a result, entries stored in a phone book increase, and a call is made after a phone number is selected from a retrieved phone book.

### SUMMARY OF THE INVENTION

The present invention is directed to a method and apparatus for selecting a communication service mode in a mobile communication terminal when a user makes a call.

The present invention is also directed to a method and apparatus capable of adding a stored prefix per connection mode in front of a selected phone number to make a call using a desired network by searching a phone book to select a desired mode from a selected display displaying connectable modes in a current position.

One aspect of the present invention provides a method of determining a mode in a multi-mode terminal including the steps of: receiving key input of a telephone number; displaying a connectable service mode corresponding to the key input of the telephone number; receiving key input corresponding to the service mode; determining a prefix corresponding to the key input of the service mode; and adding the determined prefix in front of the telephone number to be transmitted, wherein the connectable service mode is automatically renewed in the region where the service is provided.

The connectable service mode may comprise Code Division Multiple Access (CDMA), Wireless Broadband (WiBro), Wireless LAN (WLAN), and Public Switched Telephone Network (PSTN). Also, the prefix may be stored in a memory of a mobile communication terminal in response to the service mode. Furthermore, the prefix may be added to the front of the telephone number to be dialed and may be transmitted. In addition, the connectable service mode may comprise the steps of: requesting a service providing base station to provide service information; receiving the service information from the service providing base station; and renewing a service mode in response to the received service information. Moreover, requesting the service information may be performed after a previously set standby time is over. Also, the service providing base station may comprise a Base Transceiver Station (BTS) and an Access Point (AP).

Another aspect of the present invention provides a multi-mode terminal including: a key input unit for receiving key input corresponding to a service mode and key input of a telephone number; a display unit for displaying a connectable service mode corresponding to the key input of the telephone number, which is input by the key input unit; a prefix determination unit for determining a prefix corresponding to the key input of the service mode, which is input by the key input unit; and a transceiver for adding the prefix determined by the prefix determination unit in front of the telephone number to transmit the telephone number, wherein the connectable service mode is automatically renewed in a region that provides the service.

The prefix may be stored in a memory of a mobile communication terminal in response to the service mode. Also, an information request unit for requesting a service providing base station to provide service information, an information receiver for receiving service information from the service providing base station, and a service renewal unit for renewing a service mode in response to the received service information may be further included. Further, requesting service information may be performed after a previously set standby time is over. In addition, the service providing base station may comprise a BTS and an AP.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates the configuration of a service according to an exemplary embodiment of the present invention;

FIG. 2 illustrates a method of selecting a telecommunication service mode according to an exemplary embodiment of the present invention;

FIG. 3 illustrates a method of automatically renewing a service mode according to an exemplary embodiment of the present invention;

FIG. 4 illustrates a database in which service modes have different prefixes, according to an exemplary embodiment of the present invention; and

FIG. 5 illustrates an example of a service according to an exemplary embodiment of the present invention.

### DETAILED DESCRIPTION OF EMBODIMENTS

The present invention will now be described more fully hereinafter with reference to the accompanying drawings, in which exemplary embodiments of the invention are shown. This invention may, however, be embodied in different forms and should not be construed as limited to the exemplary embodiments set forth herein.

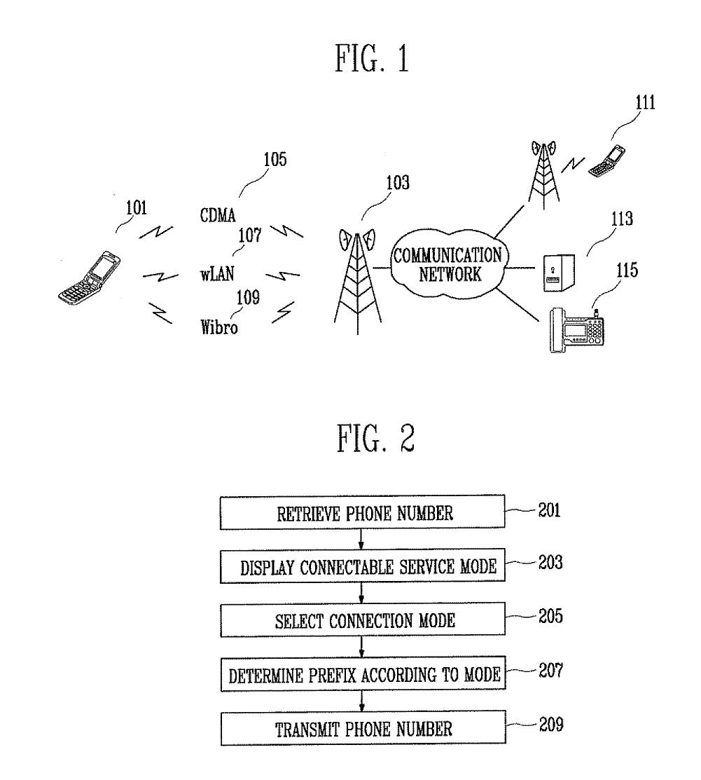

FIG. 1 illustrates the configuration of a service according to an exemplary embodiment of the present invention.

Referring to FIG. 1, the service of the present invention includes a mobile communication terminal 101, a mobile communication base station 103 communicating with the mobile communication terminal 101, communication networks 105, 107 and 109 used for communication with the base station, and receiving terminals 111, 113 and 115 connected to the communication networks.

Here, the mobile communication terminal 101 may refer to any kind of mobile communication terminal capable of wirelessly exchanging voice or data information with a base station or a satellite, as well as a general portable mobile communication terminal such as a Code Division Multiple Access (CDMA) or a Global System for Mobile communication (GSM) terminal.

Also, the mobile communication terminal 101 may include a wireless terminal capable of supporting two or more communication service modes. For example, the mobile communication terminal 101 may include a dual-mode terminal supporting both the CDMA mode or the GSM mode and a multi-mode terminal supporting other types of communication modes.

The mobile communication base station 103 refers to any type of base station transmitting and receiving a signal to/from the mobile communication terminal 101 using a specific communication type. In other words, a CDMA-based Base Transceiver Station (BTS), a wireless-LAN (WLAN), an Access Point (AP), etc. may be the mobile communication base station 103 of the present invention. When the mobile communication terminal 101 supports satellite communication, a communication satellite may be an example of the mobile communication base station 103 as well.

Also, the mobile communication base station 103 may be a base station capable of simultaneously supporting various communication modes like the mobile communication terminal 101. For example, a base station capable of supporting both a WiBro mode and a CDMA mode may be an example of the mobile communication base station 103 of the present invention.

Each of the communication networks 105, 107 and 109 is determined by an actually used communication mode. For example, when the mobile communication terminal 101 and the mobile communication base station 103 use general mobile communication, they will communicate with a base station using a CDMA 105. Further, when the terminal wirelessly communicates with the base station in the Hot Spot region, a WLAN 107 method will be used. Furthermore, a WiBro 109 may be used when a user is provided with wireless communication while walking on the street.

Characteristics of each of the receiving terminals 111, 113 and 115 may vary depending on each communication mode. The receiving terminals 111, 113 and 115 may be mobile terminals, servers, wired telephones, etc. depending on a desired mode of the transmitting mobile communication terminal 101.

FIG. 2 illustrates a method of selecting a communication service mode according to an exemplary embodiment of the present invention.

Referring to FIG. 2, a telephone number to be dialed is retrieved in a multi-mode terminal (step 201). Then, a telephone number stored in the terminal is selected, and communication service modes that can be connected to the selected telephone number are displayed (step 203).

A user of the terminal selects one of the service modes (step 205), and the terminal determines a prefix depending on the selected service mode (step 207). The prefix refers to a value by which the multi-mode terminal determines a communication service mode. Detailed descriptions thereof will be made with reference to FIG. 4.

Afterwards, the terminal transmits the selected telephone number and the prefix corresponding to the selected service mode to a base station (step 209).

When the service mode is selected using the above method, a user can communicate in a region using a desired method even when the user knows only one telephone number.

For example, given that both a wired telephone service and a mobile communication service are available in the same region, the wired telephone service may be cheaper than the mobile communication. In this case, when the wired telephone service is selected from service modes displayed on the terminal of the present invention, a prefix is automatically added in front of the phone number in the terminal to thereby connect to the wired telephone service mode.

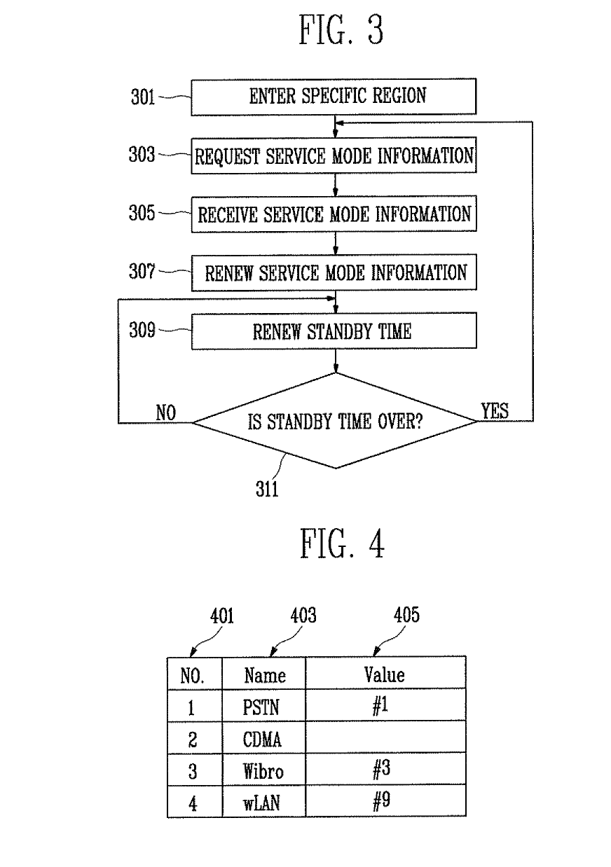

FIG. 3 illustrates a method of automatically renewing a service mode according to an exemplary embodiment of the present invention.

Referring to FIG. 3, a terminal according to the present invention enters a specific region (step 301). Then, the terminal requests a base station that can provide every service mode available in the region (step 303). The request for service mode information is made to renew information on service modes that the terminal can provide in the region.

Afterwards, the terminal receives information on the available service modes in the region from the base station (step 305). Then, the information on the available service modes is renewed in the terminal (step 307). The communication service modes to be displayed may vary depending on the renewed information.

Subsequently, service mode information request standby time of the terminal is renewed (step 309), and it is confirmed whether the service mode information request standby time is over (step 311). When the standby time is over, the terminal returns to step 303 to perform the above process again. Alternatively, when the standby time is not over, step 309 is performed again.

This method enables the service modes applicable in the region to be automatically renewed in the multi mode terminal. As a result, a user need not check the most efficient service mode in a region.

FIG. 4 illustrates a database showing different prefixes of service modes according to an exemplary embodiment of the present invention.

Referring to FIG. 4, communication service modes shown in this figure are a Public Switched Telephone Network (PSTN), a CDMA, a WLAN and WiBro.

Here, reference numeral 401 refers to a field that indicates identification numbers of the database. As the number of service modes that the mobile terminal can provide is increased, the identification numbers must be increased as well. Since four (4) types of services are provided in this exemplary embodiment, four (4) identification numbers exist.

Reference numeral 403 refers to a field that indicates the names of available service modes. According to an exemplary embodiment of the present invention, a mobile communication terminal that uses this database can provide PSTN, CDMA, WiBro and WLAN services.

Reference numeral 405 refers to prefixes to be included according to the service types.

The prefix is used when a service mode is determined in the mobile communication terminal of the present invention. Given that the terminal of the present invention designates a specific receiving telephone number to establish communication using a specific service mode, different telephone numbers will be used according to the service modes. However, in this case, every telephone number according to every service mode should be saved in memory.

Therefore, in the present invention, the prefix is added in front of the same telephone number to be transmitted, so that the service mode varies depending on each prefix.

The prefix of the present invention is set to #1 for the PSTN, #3 for the WiBro and #9 for the WLAN.

Meanwhile, because the CDMA is generally supported by a mobile communication terminal, no prefix is set for the CDMA.

That is, when a telephone number is selected without selecting a prefix in front of the number, a call is made using the mobile communication.

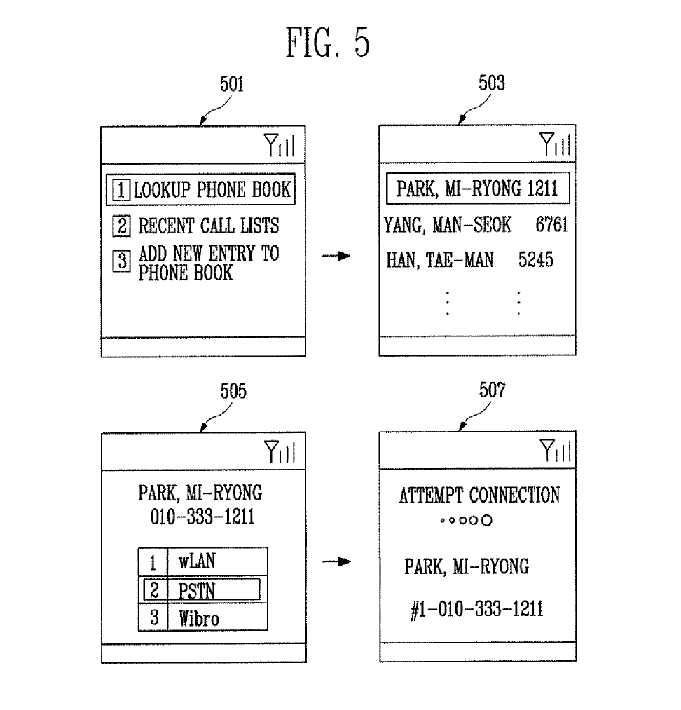

FIG. 5 illustrates an example of a service according to an exemplary embodiment of the present invention.

FIG. 5 illustrates a screen of a mobile communication terminal according to an exemplary embodiment of the present invention. Reference numeral 501 is a screen for searching for a telephone number in a mobile communication terminal. This is just an example to clarify the present invention, and a method of directly inputting a telephone number may be applied in the present invention as well.

In reference numeral 501, after a menu of “searching for a phone book” is selected, a specific person to be called is selected from the phone book. In the present exemplary embodiment, a person named “Park, Miryong” is selected (step 503).

After a person to be called is selected, communication service modes are displayed (step 505). The communication service modes are automatically set in the mobile communication terminal by the method described in FIG. 3. Therefore, a user need not consider services that are not provided in a region where the user is positioned from among communication services displayed in the menu. In reference numeral 505, the “PSTN” service is selected.

Reference numeral 507 is a screen for establishing communication with the selected telephone number using the selected service mode.

As illustrated in reference numeral 507, since the user selects the “PSTN” service, a prefix is added in front of the selected person's number to be connected, and a prefix “#1” for the PSTN is added in front of the number to be transmitted.

According to the present invention, in a mobile communication terminal capable of providing various communication services, a user can be provided with a desired communication service using the same phone book even when prefixes are different from each other depending on the communication services. Therefore, the user can be provided with the desired service.

Also, the present invention enables a phone book to be further simplified and meets the user's requirement for service quality.

Exemplary embodiments of the invention are shown in the drawings and described above in specific terms. However, no part of the above disclosure is intended to limit the scope of the overall invention. It will be understood by those of ordinary skill in the art that various changes in form and details may be made to the exemplary embodiments without departing from the spirit and scope of the present invention as defined by the following claims.

What is claimed is:

1. A method of determining a mode in a multi-mode terminal, comprising the steps of:
receiving key input of a telephone number;
displaying a connectable service mode corresponding to the key input of the telephone number;
receiving key input corresponding to the service mode;
determining a prefix corresponding to the key input of the service mode; and
adding the determined prefix in front of the telephone number to be transmitted,
wherein the connectable service mode is automatically renewed in the region where the service is provided.

2. The method of claim 1, wherein the connectable service mode comprises Code Division Multiple Access (CDMA), Wireless Broadband (WiBro), Wireless LAN (WLAN), and Public Switched Telephone Network (PSTN).

3. The method of claim 1, wherein the prefix is stored in a memory of a mobile communication terminal in response to the service mode.

4. The method of claim 1, wherein the prefix is added to the front of the telephone number to be dialed and then is transmitted.

5. The method of claim 1, further comprising the steps of:
requesting a service providing base station to provide service information;
receiving the service information from the service providing base station; and
renewing a service mode in response to the received service information.

6. The method of claim 5, wherein requesting the service information is performed after a previously set standby time is over.

7. The method of claim 5, wherein the service providing base station comprises a Base Transceiver Station (BTS) and an Access Point (AP).

8. A multi-mode terminal comprising:
a key input unit for receiving key input corresponding to a service mode and key input of a telephone number;
a display unit for displaying a connectable service mode corresponding to the key input of the telephone number, which is input by the key input unit;
a prefix determination unit for determining a prefix corresponding to the key input of the service mode, which is input by the key input unit; and
a transceiver for adding the prefix determined by the prefix determination unit in front of the telephone number to transmit the telephone number,
wherein the connectable service mode is automatically renewed in the region where the service is provided.

9. The terminal of claim 8, wherein the prefix is stored in a memory of a mobile communication terminal in response to the service mode.

10. The terminal of claim 8, further comprising:
an information request unit for requesting a service providing base station to provide service information;
an information receiver for receiving service information from the service providing base station; and
a service renewal unit for renewing a service mode in response to the received service information.

11. The terminal of claim 10, wherein requesting service information is performed after a previously set standby time is over.

12. The terminal of claim 10, wherein the service providing base station comprises a BTS and an AP.
